(19) United States
(12) Patent Application Publication
(10) Pub. No.: US 2026/0209438 A1
(43) Pub. Date: Jul. 23, 2026

(54) SOLVENT SOLUBLE POLYIMIDE

(71) Applicant: PI ADVANCED MATERIALS CO., LTD., Jincheon-gun, Chungcheongbuk-do (KR)

(72) Inventors: Min Sang CHO, Jincheon-gun (KR); Kil Nam LEE, Jincheon-gun (KR); Han Tae RYU, Jincheon-gun (KR)

(21) Appl. No.: 19/134,148

(22) PCT Filed: Nov. 24, 2023
(86) PCT No.: PCT/KR2023/019111

§ 371 Date: May 29, 2025

(30) Foreign Application Priority Data
Nov. 30, 2022 (KR) 10-2022-0165077

(51) Int. Cl. C08G 73/10; C08L 79/08

(52) U.S. Cl. CPC C08G 73/1042; C08G 73/1067; C08L 79/08

(57) ABSTRACT

Provided is a polyimide comprising: as polymerized units, a dianhydride monomer including at least one selected from the group consisting of 3,3′,4,4′-benzophenone tetracarboxylic dianhydride (BTDA), oxydiphthalic anhydride (ODPA), 4,4′-(hexafluoroisopropylidene)diphthalic anhydride (6FDA) and 3,3′,4,4′-diphenylsulfonetetracarboxylic dianhydride; and a diamine monomer including 4,4′-methylenebis(2,6-diethylaniline) (MEDA).

### TECHNICAL FIELD

The present disclosure relates to a solvent soluble polyimide. Specifically, the present disclosure relates to a polyimide being soluble in an organic solvent.

### BACKGROUND ART

In general, polyimide (PI) is based on an imide ring having excellent chemical stability together with a rigid aromatic main chain, and is a polymer material with the highest level of heat resistance, chemical resistance, electrical insulation, chemical resistance, and weather resistance among organic materials, thereby being manufactured into various forms such as films, fibers, membranes, etc. Due to these characteristics, polyimide is used, as an advanced material and insulating coating agent, in a wide range of fields such as electrical and electronics, semiconductors, displays, automobiles, aviation, and space materials.

Polyimide may be prepared by dissolving, in a solvent, acid dianhydride having two acid anhydride groups in its molecule and diamine having two amino groups in its molecule to synthesize a polyimide precursor called polyamic acid (PAA), and applying and drying the polyimide precursor, followed by heat treatment at about 350° C. to perform imidization. Since there has been a high demand to handle polyimide in a solution state, and a lot of development is underway on solvent-soluble polyimide.

However, conventional polyimide prepared by imidization through dehydration and ring closure reaction using conventional chemical method or high temperature method had insoluble properties in solvents, causing a difficulty in processing. In addition, in order to prepare polyimide soluble in solvents, in general, there is no choice but to use highly soluble monomers, but these monomers generally have low heat resistance, and the prepared polyimide had a problem of low heat resistance and low chemical resistance. Meanwhile, in order to use polyimide in the form of a solution while having heat resistance or chemical resistance, there is a method of preparing polyimide by forming a coating film with a polyamic acid solution, which is a polyimide precursor, and then performing imidization.

However, the polyamic acid solution had the disadvantages of being vulnerable to humidity and difficult to handle and store, and requiring a heat treatment process at high temperature to imidize the polyamic acid.

Under this background, there is a need to develop polyimide capable of maintaining the high heat resistance and insulation properties thereof, while being easily soluble in organic solvents and capable of manufacturing polyimide-based products only by solvent drying without an imidization process at high temperature.

### DISCLOSURE OF INVENTION

### Technical Problem

An object of the present disclosure is to provide a polyimide (PI) being soluble in an organic solvent.

Another object of the present disclosure is to provide a polyimide capable of being produced in various ways, such as films and fibers, etc., simply by drying a solvent without an imidization process at high temperature.

Still another object of the present disclosure is to provide a polyimide solution containing the polyimide.

In addition, still another object of the present disclosure is to provide polyimide powder comprising the polyimide.

Further, still another object of the present disclosure is to provide a separator comprising the polyimide.

In addition, still another object of the present disclosure is to provide a fiber comprising the polyimide.

Furthermore, still another object of the present disclosure is to provide an insulation layer comprising the polyimide.

Further, still another object of the present disclosure is to provide a coating layer comprising the polyimide.

### Solution to Problem

Various modifications can be made and various embodiments may be implemented in the present disclosure, and specific embodiments are illustrated in the drawings and described in detail. However, these embodiments are not intended to limit the present disclosure to specific embodiments, and should be understood to comprise all modifications, equivalents, and substitutes included in the spirit and scope of the present disclosure.

Terms used in the present application are only used to describe specific embodiments and are not intended to limit the present disclosure. Singular expressions include plural expressions unless the context clearly indicates otherwise. In the present specification, terms such as “comprise” or “have” are intended to designate the presence of features, numbers, steps, operations, components, parts, or combinations thereof described in the specification and it should not be understood as precluding the possibility of the presence or addition of one or more other features, numbers, steps, operations, components, parts, or combinations thereof.

When amounts, concentrations, other or values or parameters herein are given as ranges, preferred ranges, or lists of upper desirable values and lower desirable values, it should be understood as specifically disclosing all ranges formed by any pair of any upper range limit or preferred value and any lower range limit or preferred value, regardless of whether the scope is separately disclosed.

Where ranges of numerical values are stated herein, unless otherwise stated, it is intended that the endpoints of the range and the scope of the parent disclosure within the range are not limited to the specific values stated when defining the range.

As used herein, “dianhydride” is intended to include precursors or derivatives thereof, which are also referred to as “dianhydride” or “acid dianhydride”. These products may technically not be dianhydrides, but will nonetheless react with diamines to form polyamic acids, and the polyamic acids may be converted back into polyimides.

As used herein, “diamine” is intended to include precursors or derivatives thereof, which may technically not be diamines, but will nonetheless react with dianhydride acid to form a polyamic acid, and the polyamic acid may be converted back into polyimide.

Further, unless defined otherwise, all terms used herein, including technical or scientific terms, have the same meaning as commonly understood by one of ordinary skill in the art to which the present disclosure belongs. Terms such as those defined in commonly used dictionaries should be interpreted as having a meaning consistent with the meaning in the context of the related art, and unless explicitly defined in the present application, it is not to be construed in an idealized or overly formal sense. Specific details for the implementation of the disclosure will be described below.

The present disclosure relates to a polyimide (PI) being soluble in an organic solvent.

### Solvent Soluble Polyimide

In one general aspect, there is provided a polyimide comprising: as polymerized units, a dianhydride monomer including at least one selected from the group consisting of 3,3′,4,4′-benzophenone tetracarboxylic dianhydride (BTDA), oxydiphthalic anhydride (ODPA), 4,4′-(hexafluoroisopropylidene)diphthalic anhydride (6FDA) and 3,3′,4,4′-diphenylsulfonetetracarboxylic dianhydride; and a diamine monomer including 4,4′-methylenebis(2,6-diethylaniline) (MEDA).

The diamine monomer may further comprise at least one diamine monomer selected from the group consisting of 2,4-diaminotoluene (2,4-TDA), 2,6-toluenediamine (2,6-TDA), 2,4,6-trimethyl-1,3-phenylenediamine, 2,3,5,6-tetramethylbenzene-1,4-diamine, 4,4′-methylenedianiline (MDA), and phenylenediamine (PD).

Specifically, the diamine monomer may comprise 4,4′-methylenebis(2,6-diethylaniline) (MEDA) alone. Further, the diamine monomer may further comprise a combination of 4,4′-methylenebis(2,6-diethylaniline) (MEDA) and at least one diamine monomer selected from the group consisting of 2,4-diaminotoluene (2,4-TDA), 2,6-toluenediamine (2,6-TDA), 2,4,6-trimethyl-1,3-phenylenediamine, 2,3,5,6-tetramethylbenzene-1,4-diamine, 4,4′-methylenedianiline (MDA), and phenylenediamine (PD).

In an embodiment, the polyimide may comprise the dianhydride monomer 3,3′,4,4′-benzophenonetetracarboxylic dianhydride (BTDA) and the diamine monomer 4,4′-methylenebis(2,6-diethylaniline) (MEDA) as polymerized units.

In an embodiment, the polyimide may comprise the dianhydride monomer 3,3′,4,4′-benzophenonetetracarboxylic dianhydride (BTDA) and the diamine monomers 4,4′-methylenedianiline (MDA) and 4,4′-methylenebis(2,6-diethylaniline) (MEDA) as polymerized units.

In an embodiment, the polyimide may comprise the dianhydride monomer 3,3′,4,4′-benzophenonetetracarboxylic dianhydride (BTDA) and the diamine monomers 4,4′-methylenedianiline (MDA), phenylenediamine (PD), and 4,4′-methylenebis(2,6-diethylaniline) (MEDA) as polymerized units.

In an embodiment, the polyimide may comprise the dianhydride monomer 3,3′,4,4′-benzophenonetetracarboxylic dianhydride (BTDA) and the diamine monomers phenylenediamine (PD) and 4,4′-methylenebis(2,6-diethylaniline) (MEDA) as polymerized units.

In an embodiment, the polyimide may comprise the dianhydride monomer 3,3′,4,4′-benzophenonetetracarboxylic dianhydride (BTDA) and the diamine monomers 2,4-diaminotoluene (TDA) and 4,4′-methylenebis(2,6-diethylaniline) (MEDA) as polymerized units.

The phenylenediamine (PD) may comprise at least one selected from the group consisting of o-phenylenediamine (o-PD) and m-phenylenediamine (m-PD),
preferably m-phenylenediamine (m-PD).

Among all diamine monomers, the 4,4′-methylenebis(2,6-diethylaniline) (MEDA) may have an amount of 60 mol % or more, preferably 60 to 110 mol %, and more preferably 60 to 100 mol %. For example, the lower limit thereof may be 61 mol %, 62 mol %, 63 mol %, 64 mol %, or 65 mol % or more.

When the amount of 4,4′-methylenebis(2,6-diethylaniline) (MEDA) is less than 60 molo, it is not preferable since solubility in organic solvents is not secured.

Among all diamine monomers, at least one diamine monomer selected from the group consisting of 2,4-diaminotoluene (2,4-TDA), 2,6-toluenediamine (2,6-TDA), 2,4,6-trimethyl-1,3-phenylenediamine, 2,3,5,6-tetramethylbenzene-1,4-diamine, 4,4′-methylenedianiline (MDA), and phenylenediamine (PD) may have an amount of 40 mol % or less. Specifically, the amount may be 0 to 40 mol %. For example, the upper limit thereof may be 39 mol %, 38 mol %, 37 mol %, 36 mol %, or 35 mol %. The term 0 mol % means that among all diamine monomers, none of 2,4-diaminotoluene (2,4-TDA), 2,6-toluenediamine (2,6-TDA), 2,4,6-trimethyl-1,3-phenylenediamine, 2,3,5,6-tetramethylbenzene-1,4-diamine, 4,4′-methylenedianiline (MDA), and phenylenediamine (PD) is contained.

The polyimide may comprise the diamine monomer in an amount of 90 to 110 molo, preferably 95 to 105 mol %, and more preferably 100 mol %.

The polyimide may comprise the dianhydride monomer in an amount of 90 to 110 mol %, preferably 95 to 105 mol %, and more preferably 100 mol %.

The polyimide may comprise the dianhydride monomer and the diamine monomer at a molar ratio of 6:4 to 4:6, preferably at a molar ratio of 5:5.

The polyimide has excellent solubility in an organic solvent for a solid content of 15 wt %, 16 wt %, 17 wt %, 18 wt %, 19 wt %, 20 wt %, and 25 wt % or more. In an embodiment, the degree of turbidity of the solution was visually confirmed by adding 20-25 wt % of polyimide solids at room temperature, followed by stirring for 30 minutes.

The organic solvent may be an aprotic polar organic solvent, and specifically, may comprise at least one selected from the group consisting of N-methyl-pyrrolidone (NMP), N,N′-dimethylformamide (DMF), N,N′-diethylformamide (DEF), N,N′-dimethylacetamide (DMAc), dimethylpropanamide (DMPA) and N, N-diethylacetamide (DEAc).

In the present disclosure, a thermal decomposition temperature (Td) and a glass transition temperature (Tg) were measured, in which the thermal decomposition temperature is mainly used as a standard for judging thermal properties of polyimide, and the glass transition temperature is able to predict thermal properties while also determining mechanical properties.

The glass transition temperature (Tg) of the polyimide may be 250° C. or higher. For example, the lower limit of the glass transition temperature of the polyimide may be 255° C., 260° C., 265° C., 270° C., or 275° C. or higher. The glass transition temperature may be measured for polyimide at 10° C./min using dynamic mechanical analysis (DMA).

The thermal decomposition temperature (Td) at 5% weight loss of the polyimide may be 400° C. or higher. For example, the lower limit of the thermal decomposition temperature of the polyimide may be 410° C., 415° C., 420° C., 425° C., 430° C., or 435° C. or higher. The thermal decomposition temperature may be measured using TA's thermogravimetric analyzer Q50. In a specific example, the polyimide may be heated up to 100° C. at a rate of 10° C./min under a nitrogen atmosphere and then maintained isothermally for 30 minutes to remove moisture. Then, the temperature at which a 5% weight loss occurs by heating up to 600° C. at a rate of 10° C./min may be measured.

The polyimide of the present disclosure is characterized by excellent solubility in an organic solvent while maintaining excellent thermal properties.

The polyimide of the present disclosure may secure soluble properties by comprising a combination of the specific dianhydride monomer and diamine monomer while comprising 60 mol % or more of MEDA, and thus the polyimide is easily soluble in an organic solvent and is able to be manufactured into films, fibers, and the like, simply by drying the solvent without an imidization process at high temperature.

In another general aspect, there is provided a polyimide solution comprising the polyimide and an organic solvent.

The polyimide of the present disclosure has excellent solubility in an organic solvent, which has an advantage in that it can be easily used for polyimide films, fiberization, or coating by using the polyimide in the form of a solution dissolved in an organic solvent.

In the present disclosure, the polyimide solution may have a polyimide solid content of 15 to 60 wt % based on 100 parts by weight of the polyimide solution. The lower limit for wt % of solid content may be 16, 17, 18, 19, 20, 21, 22, 23, 24, 25, 26, 27, 28, 29, 30, 31, 32, 33, 34 or 35 wt % or more, and the upper limit for wt % of solid content may be 55, 50, 45, 40, 37, or 35 wt % or less. By adjusting the solid content of the polyimide solution, it is possible to control the increase in viscosity and to shorten the processing time during the curing process.

In an exemplary embodiment, the polyimide solution of the present disclosure may have a viscosity in the range of 200 to 50,000 cP, the viscosity being measured at a temperature of 23° C. and a shear rate of 1s⁻¹. Specifically, the lower limit of the viscosity of the polyimide solution may be 500 cP or more, 1,000 cP or more, 1,200 cP or more, 1,500 cP or more, 1, 600 cP or more, 1,700 cP or more, 2,000 cP or more, 2,200 cP or more, 2,500 cP or more, 2,600 cP or more, 2,700 cP or more, 5,500 cP or more, 5,900 cP or more, 5,980 cP or more, 6,500 cP or more, 7,000 cP or more, 8,000 cP or more, 10,000 cP or more, 11,000 cP or more, 12,200 cP or more, 13,000 cP or more, 14,000 cP or more, 14,350 cP or more, 14,400 cP or more, 14,500 cP or more, 15,000 cP or more, or 15,500 CP or more. The upper limit thereof may be 49,000 cP or less, 45,000 cP or less, 40,000 cP or less, 30,000 cP or less, 25,000 cP or less, 20,000 cP or less, 18,000 cP or less, 16,000 cP or less, 15,500 cP or less, 15,000 cP or less, 14,500 cP or less, 8,000 cP or less, 5,000 cP or less, 3,500 cP or less, or 2,900 cP or less. In the present application, it is possible to manufacture a cured polyimide product with excellent processability and desired physical properties, by adjusting the viscosity range of the polyimide solution.

In still another aspect, there is provided polyimide powder comprising the polyimide of the present disclosure.

In still another aspect, there is provided a polyimide film comprising the polyimide of the present disclosure.

Further, in still another aspect, there is provided a component comprising a molded body formed from the polyimide.

Specifically, the component may comprise, but not limited to, electronic circuit board members, semiconductor devices, lithium ion battery members, solar cell members, fuel cell members, motor windings, engine peripheral members, paints, optical components, heat insulators, electromagnetic shielding materials, surge components, dental materials, slide coating, and electrostatic chuck.

Further, in still another aspect, there is provided a separator comprising the polyimide as described above.

In addition, in still another aspect, there is provided a fiber comprising the polyimide as described above.

Further, in still another aspect, there is provided an insulation layer comprising the polyimide as described above.

In addition, in still another aspect, there is provided a coating layer comprising the polyimide as described above.

### Advantageous Effects of Invention

The polyimide according to the present disclosure may be soluble in an organic solvent, and may be able to be manufactured into films, fibers, and the like, simply by drying the solvent without an imidization process at high temperature, thereby improving the ease of processing.

In addition, the polyimide according to the present disclosure may have excellent thermal properties while simultaneously exhibiting excellent solubility in an organic solvent.

Further, the polyimide according to the present disclosure is able to be applicable to various fields such as insulation coatings, fibers, membranes, etc.

### BEST MODE FOR CARRYING OUT THE INVENTION

The following Examples are presented to facilitate the understanding of the present disclosure. These Examples are only provided to more easily understand the present disclosure, but the content of the present disclosure is not limited by the following Examples.

### Example

### Example 1: Preparation of Polyimide

To dimethylformamide (DMF) organic solvent, 3,3′,4,4′-benzophenonetetracarboxylic dianhydride (BTDA) and 4,4′-methylenebis(2,6-diethylaniline (MEDA) were added in a nitrogen/room temperature atmosphere, stirred and reacted to obtain a polyamic acid (PAA) composition. The organic solvent may be at least one selected from dimethylformamide (DMF), methylpyrrolidone (NMP), and dimethylacetamide (DMAc), but is not limited thereto.

To the obtained polyamic acid composition, a tertiary catalyst (BP, betapicoline) and a dehydrating agent (acetic anhydride, AA) were added, and the resulting mixture was subjected to a chemical imidization process in a continuous polymerization batch process at 60° C.

After completion of the reaction, the polymer was precipitated in ethanol non-solvent to remove impurities (unreacted products, tertiary catalyst, AA, and the like), and a product in powder form was obtained. Here, the tertiary catalyst may be any tertiary amine catalyst, and specifically, pyridine, β-picoline (BP), isoquinoline (IQ), or the like, but is not limited thereto. In addition, the non-solvent is provided for precipitation and may be at least one selected from the group consisting of water, methanol, ethanol, n-propanol, isopropanol, butanol, butanediol, ethylene glycol, glycerol, gamma-butyrolactone, or a mixture thereof, but is not limited to thereto.

Then, the resulting product was dried in a vacuum oven at 60° C. for 24 hours to obtain polyimide powder.

### Examples 2 to 6

Polyimide powder was prepared in the same manner as in Example 1, except that components and amount ratios of the monomers were adjusted as shown in Table 1 below.

### Example 7

To N-methyl-pyrrolidone (NMP) organic solvent, 3,3′,4,4′-benzophenonetetracarboxylic dianhydride (BTDA) and 4,4′-methylenebis(2,6-diethylaniline (MEDA) were added in a nitrogen/room temperature atmosphere, stirred and reacted to obtain a polyamic acid (PAA) composition. Here, the components and amounts of the polyamic acid (PAA) composition were the same as in Example 1.

Subsequently, the obtained polyamic acid composition was heated to 180° C. and stirred at that temperature for 2 to 4 hours to obtain a polyimide solution through a thermal imidization process. After completion of the reaction, impurities were removed and the resulting product was dried in a vacuum oven at 60° C. for 24 hours to obtain polyimide powder.

### Examples 8 to 12

Polyimide powder of Examples 8 to 12 was prepared in the same manner as in Example 7, except that the components and amounts of the polyamic acid (PAA) composition were adjusted to be the same as those in Examples 2 to 6, respectively.

### Comparative Examples 1 to 4

Polyimide was prepared in the same manner as in Example 1, except that components and amount ratios of the monomers were adjusted as shown in Table 1 below.

TABLE 1

| | | | Diamine monomers (mol %) | | | | |
|---|---|---|---|---|---|---|---|
| | | | | | | | Second |
| | Dianhydride | | | | | | diamine |
| | monomers (mol %) | | First diamine monomer | | | | monomer |
| Classification | PMDA | BTDA | TDA | MDA | MPD | ODA | MEDA |
| Example 1 | — | 100 | — | — | — | — | 100 |
| Example 2 | — | 100 | — | 25 | — | — | 75 |
| Example 3 | — | 100 | — | 35 | — | — | 65 |
| Example 4 | — | 100 | — | 20 | 15 | — | 65 |
| Example 5 | — | 100 | — | — | 35 | — | 65 |
| Example 6 | — | 100 | 35 | — | — | — | 65 |
| Comparative | — | 100 | — | — | — | 35 | 65 |
| Example 1 | | | | | | | |
| Comparative | — | 100 | — | — | 50 | — | 50 |
| Example 2 | | | | | | | |
| Comparative | — | 100 | — | 43 | — | — | 57 |
| Example 3 | | | | | | | |
| Comparative | 10 | 90 | — | 35 | — | — | 65 |
| Example 4 | | | | | | | |

The abbreviated names of substances used in Table 1 above are as follows.
PMDA: Pyromellitic dianhydride
BTDA: 3,3′,4,4′-benzophenone tetracarboxylic dianhydride
TDA: 2,4-diaminotoluene
MDA: 4,4′-methylenedianiline
MPD: m-phenylenediamine
ODA: 4,4′-oxydianiline
MEDA: 4,4′-methylenebis(2,6-diethylaniline)

### EXPERIMENTAL EXAMPLES

### Experimental Example 1. Evaluation of Solubility

The solubility of polyimide in an organic solvent was evaluated by adding 20 g of polyimide powder prepared according to Examples 1 to 6 and Comparative Examples 1 to 4 into 80 g of organic solvent, N,N′-dimethylformamide (DMF), and visually confirming the solution.

Specifically, 20 wt % or 25 wt % of polyimide solid content was added thereto, respectively, at room temperature, then the solution was stirred for 30 minutes, and the degree of turbidity of the solution was confirmed visually. As solubility test results, a transparent solution with a clear color without suspension matters was determined as “soluble,” and other cases were determined as “insoluble.” The results of the solubility analysis are shown in Table 2 below.

### Experimental Example 2. Glass Transition Temperature (Tg)

For each polyimide prepared according to Examples 1 to 6 and Comparative Examples 1 to 4, the point at which the polyimide rapidly expands at 10° C./min was measured as the on-set point using dynamic mechanical analysis (DMA). Results thereof are shown in Table 2.

### Experimental Example 3. Thermal Decomposition Temperature (Td) at 5% Weight Loss

TA's thermogravimetric analyzer Q50 was used, and each polyimide prepared according to Examples 1 to 6 and Comparative Examples 1 to 4 was heated up to 100° C. at a rate of 10° C./min under a nitrogen atmosphere and then maintained isothermally for 30 minutes to remove moisture. Then, the temperature at which a 5% weight loss occurred by heating up to 600° C. at a rate of 10° C./min was measured. Results thereof are shown in Table 2 below.

Table 2 below shows results of the solubility, glass transition temperature (Tg), and thermal decomposition temperature (Td) at 5% weight loss of the polyimides prepared according to Examples 1 to 6 and Comparative Examples 1 to 4.

TABLE 2

| | Solubility in | | Glass | Thermal |
|---|---|---|---|---|
| | organic solvent | | transition | decomposition |
| | DMF | | temperature | temperature (Td) |
| Classification | 20 wt % | 25 wt % | (Tg) | at 5% weight loss |
| Example 1 | soluble | soluble | 309° C. | 439° C. |
| Example 2 | soluble | soluble | 298° C. | 468° C. |
| Example 3 | soluble | soluble | 287° C. | 471° C. |
| Example 4 | soluble | soluble | 284° C. | 471° C. |
| Example 5 | soluble | soluble | 278° C. | 471° C. |
| Example 6 | soluble | soluble | 291° C. | 478° C. |
| Comparative | insoluble | insoluble | — | — |
| Example 1 | | | | |
| Comparative | insoluble | insoluble | — | — |
| Example 2 | | | | |
| Comparative | insoluble | insoluble | — | — |
| Example 3 | | | | |
| Comparative | insoluble | insoluble | — | — |
| Example 4 | | | | |

It could be confirmed from Table 2 that the polyimides according to Examples 1 to 6 not only had excellent solubility in DMF, an aprotic polar organic solvent, but also maintained excellent thermal properties.

On the other hand, the polyimides of Comparative Examples 2 and 3 comprising less than 60 mol % MEDA showed no solubility in DMF and no thermal properties.

In addition, the polyimide of Comparative Example 4 further comprising PMDA as a dianhydride monomer, and the polyimide of Comparative Example 1 further comprising ODA as a diamine monomer, also did not exhibit solubility in DMF and thermal properties.

From these results, it could be confirmed that the polyimide comprising a combination of the specific dianhydride monomer and diamine monomer while comprising 60 mol % or more of MEDA had soluble properties in aprotic polar organic solvents (e.g., DMF) and maintained excellent thermal properties unique to polyimide.

In the specification, details capable of being sufficiently recognized and inferred by those skilled in the art of the present disclosure are omitted, and various modifications can be made within the scope that does not change the technical spirit or essential configuration of the present disclosure other than the specific examples described in the present specification. Therefore, the present disclosure may be practiced in other ways than specifically described and exemplified herein, which can be understood by those skilled in the art.

1-14. (canceled)

15. A polyimide comprising: as polymerized units,
a dianhydride monomer including at least one selected from the group consisting of 3,3′,4,4′-benzophenone tetracarboxylic dianhydride (BTDA), oxydiphthalic anhydride (ODPA), 4,4′-(hexafluoroisopropylidene)diphthalic anhydride (6FDA), and 3,3′,4,4′-diphenylsulfonetetracarboxylic dianhydride; and
a diamine monomer including 4,4′-methylenebis(2,6-diethylaniline) (MEDA).

16. The polyimide of claim 15, wherein the diamine monomer further comprises at least one diamine monomer selected from the group consisting of 2,4-diaminotoluene (2,4-TDA), 2,6-toluenediamine (2,6-TDA), 2,4,6-trimethyl-1,3-phenylenediamine, 2,3,5,6-tetramethylbenzene-1,4-diamine, 4,4′-methylenedianiline (MDA), and phenylenediamine (PD).

17. The polyimide of claim 15, wherein the dianhydride monomer comprises 3,3′,4,4′-benzophenonetetracarboxylic dianhydride (BTDA); and the diamine monomer comprises 4,4′-methylenebis(2,6-diethylaniline) (MEDA).

18. The polyimide of claim 16, wherein the dianhydride monomer comprises 3,3′,4,4′-benzophenonetetracarboxylic dianhydride (BTDA); and the diamine monomer comprises 4,4′-methylenedianiline (MDA) and 4,4′-methylenebis(2,6-diethylaniline) (MEDA).

19. The polyimide of claim 16, wherein the dianhydride monomer comprises 3,3′,4,4′-benzophenonetetracarboxylic dianhydride (BTDA); and the diamine monomer comprises 4,4′-methylenedianiline (MDA), phenylenediamine (PD) and 4,4′-methylenebis(2,6-diethylaniline) (MEDA).

20. The polyimide of claim 16, wherein the dianhydride monomer comprises 3,3′,4,4′-benzophenonetetracarboxylic dianhydride (BTDA); and the diamine monomer comprises phenylenediamine (PD) and 4,4′-methylenebis(2,6-diethylaniline) (MEDA).

21. The polyimide of claim 16, wherein the dianhydride monomer comprises 3,3′,4,4′-benzophenonetetracarboxylic dianhydride (BTDA); and the diamine monomer comprises 2,4-diaminotoluene (TDA) and 4,4′-methylenebis(2,6-diethylaniline) (MEDA).

22. The polyimide of claim 16, wherein the phenylenediamine (PD) comprises at least one selected from the group consisting of o-phenylenediamine (o-PD) and m-phenylenediamine (m-PD).

23. The polyimide of claim 15, wherein the 4,4′-methylenebis(2,6-diethylaniline) (MEDA) has an amount of 60 mol % or more in all diamine monomers.

24. The polyimide of claim 16, wherein the at least one diamine monomer selected from the group consisting of 2,4-diaminotoluene (2,4-TDA), 2,6-toluenediamine (2,6-TDA), 2,4,6-trimethyl-1,3-phenylenediamine, 2,3,5,6-tetramethylbenzene-1,4-diamine, 4,4′-methylenedianiline (MDA), and phenylenediamine (PD) has an amount of 40 mol % or less in all diamine monomers.

25. The polyimide of claim 15, wherein the polyimide comprises the dianhydride monomer and the diamine monomer at a molar ratio of 6:4 to 4:6.

26. The polyimide of claim 15, wherein the polyimide exhibits soluble properties in an organic solvent for a solid content of 15 wt % or more.

27. The polyimide of claim 26, wherein the organic solvent comprises at least one selected from the group consisting of N-methyl-pyrrolidone (NMP), N,N′-dimethylformamide (DMF), N,N′-diethylformamide (DEF), N,N′-dimethylacetamide (DMAc), dimethylpropanamide (DMPA), and N,N-diethylacetamide (DEAc).

28. The polyimide of claim 15, wherein a glass transition temperature (Tg) of the polyimide is 250° C. or higher.

29. The polyimide of claim 15, wherein a thermal decomposition temperature (Td) at 5% weight loss of the polyimide is 400° C. or higher.

30. A polyimide solution comprising the polyimide according to claim 15 and an organic solvent.

31. The polyimide solution of claim 30, wherein a polyimide solid content is 15 to 60 wt %.

32. The polyimide solution of claim 30, wherein the polyimide solution has a viscosity in the range of 200 to 50,000 cP as measured at a temperature of 23° C. and a shear rate of 1s⁻¹.

33. The polyimide solution of claim 30, wherein the organic solvent comprises at least one selected from the group consisting of N-methyl-pyrrolidone (NMP), N,N′-dimethylformamide (DMF), N,N′-diethylformamide (DEF), N,N′-dimethylacetamide (DMAc), dimethylpropanamide (DMPA), and N,N-diethylacetamide (DEAc).

34. Polyimide powder comprising the polyimide according to claim 15.
